(19) United States
(12) Patent Application Publication
(10) Pub. No.: US 2018/0032193 A1
(43) Pub. Date: Feb. 1, 2018

(54) TOUCH PANEL AND MANUFACTURING METHOD THEREOF, DISPLAY APPARATUS HAVING THE SAME

(71) Applicants: BOE Technology Group Co., Ltd., Beijing (CN); Beijing BOE Display Technology Co., Ltd., Beijing (CN)

(72) Inventor: Lianjie QU, Beijing (CN)

(21) Appl. No.: 15/661,009

(22) Filed: Jul. 27, 2017

(30) Foreign Application Priority Data
Jul. 29, 2016 (CN) 201610616781.6

(51) Int. Cl. G06F 3/041; G02F 1/1343; G02F 1/1335; G06F 3/044; G02F 1/1333

(52) U.S. Cl. CPC G06F 3/0412; G06F 3/044; G02F 1/13338; G02F 1/133512; G02F 1/133516; G02F 1/13439; G02F 1/134309; G02F 1/133345; G06F 2203/04111; G06F 2203/04103

(57) ABSTRACT

The present disclosure provides a touch panel, a manufacturing method thereof, and a display apparatus having the same. The touch panel includes a touch area and a bonding area arranged at a side of the touch area. The touch area includes a plurality of touch sensing electrode blocks. The bonding area is provided therein with a touch chip. Each of the touch sensing electrode blocks is electrically connected with at least one lead configured to provide signal to the touch sensing electrode block. The lead is configured to pass through the touch area and extend out from a side of the touch area close to the bonding area, thereby connecting with the touch chip provided in the bonding area.

### FIELD

The present disclosure relates to the field of touch display technologies, and particularly, to a touch panel, a manufacturing method thereof, and a display apparatus having the same.

### BACKGROUND

In-cell touch display apparatus is manufactured by integrating touch electrodes on an inner side or an outer side of a substrate of a liquid crystal display apparatus, such that the display apparatus are made thinner and lighter. In the conventional in-cell touch display apparatus, leads such as a touch signal line connected with a touch electrode block and a sensing signal line connected with a sensing electrode block are required to be arranged in a peripheral area of the display apparatus. Since these leads are generally made of a non-transparent metal material, they are generally arranged within an area of a bottom frame and areas of side frames, so as to avoid their impacts on light transmittance. For this reason, three frames of the display apparatus have a relatively large width, so the requirements for frameless or narrow frame are hardly to be satisfied.

### SUMMARY

To at least partially solve the above problems, the present disclosure provides a touch panel, a manufacturing method thereof, and a display apparatus having the same, which can achieve frameless or narrow frame.

In one aspect, the present disclosure provides a touch panel, including a touch area which includes a plurality of touch sensing electrode blocks and a bonding area arranged at a side of the touch area and provided therein with a touch chip, wherein each of the touch sensing electrode blocks is electrically connected with at least one lead configured to provide signal to the touch sensing electrode block, and the lead is configured to pass through the touch area and extend out from a side of the touch area close to the bonding area, thereby connecting with the touch chip provided in the bonding area.

Optionally, each of the touch sensing electrode blocks is connected with a plurality of leads configured to provide signal to the touch sensing electrode block, and the plurality of leads are connected with each other in parallel.

Optionally, an insulating layer is arranged between the touch sensing electrode block and the lead, and a through hole is provided at a position of the insulating layer corresponding to one end of the lead, the lead being electrically connected with the touch sensing electrode block via the through hole.

Optionally, the touch panel further includes a black matrix structure arranged within the touch area, and the black matrix structure includes a black matrix strip in a row direction and a black matrix strip in a column direction, the lead being configured to extend along the black matrix strip in the row direction and/or the black matrix strip in the column direction and be covered by the black matrix strip.

Optionally, the black matrix structure is arranged between the touch sensing electrode block and the lead and is made of an insulating material, and a through hole is provided at a position of the black matrix structure corresponding to one end of the lead, the lead being electrically connected with the touch sensing electrode block via the through hole.

Optionally, the plurality of touch sensing electrode blocks are arranged in a same layer and arranged in an array form, and includes sensing electrode blocks in a row direction and touch electrode blocks in a column direction, adjacent sensing electrode blocks are connected with each other through a connection part arranged in the same layer as the sensing electrode block, adjacent touch electrode blocks are connected with each other through a connection bridge.

Optionally, the touch panel further includes a black matrix structure arranged within the touch area, and the black matrix structure includes a black matrix strip in a row direction and a black matrix strip in a column direction, the lead being configured to extend along the black matrix strip in the row direction and/or the black matrix strip in the column direction and be covered by the black matrix strip, the connection bridge being configured to extend along the black matrix strip in the column direction and covered by the black matrix strip.

Optionally, the connection bridge and the lead are arranged in a same layer, and the connection bridge is insulated from the connection part.

Optionally, the lead includes a sensing single line configured to provide sensing signal to the sensing electrode block and a touch signal line configured to provide touch signal to the touch electrode block, the sensing electrode blocks in a same row being electrically connected with a same sensing signal line, the touch electrode blocks in a same column being electrically connected with a same touch signal line.

Optionally, the touch panel further includes a color filter substrate, and the touch sensing electrode blocks are arranged on the color filter substrate.

In another aspect, the present disclosure further provides a method of fabricating a touch panel, including: forming a black matrix structure on a color filter substrate; forming a plurality of touch sensing electrode blocks on the black matrix structure; forming an insulating layer on the touch sensing electrode blocks; forming, on the insulating layer, at least one lead configured to provide signal to the touch sensing electrode block for each touch sensing electrode block, wherein the lead is formed to be electrically connected with the touch sensing electrode block via a through hole in the insulating layer, and the lead is formed to pass through the touch area and extend out from a side of the touch area close to the bonding area, thereby connecting with the touch chip provided in the bonding area.

In another aspect, the present disclosure further provides a method of fabricating a touch panel, including: forming, through a deposition process, a plurality of touch sensing electrode blocks on a color filter substrate, the touch sensing electrode block is made of a transparent conductive material; depositing a layer of a black matrix material and patterning the black matrix material to form a black matrix structure, the black matrix material being an insulating material; and forming, on the black matrix structure, at least one lead configured to provide signal to the touch sensing electrode block for each touch sensing electrode block, wherein the lead is formed to be electrically connected with the touch sensing electrode block via a through hole in the matrix structure, and the lead is formed to pass through the touch area and extend out from a side of the touch area close to the bonding area, thereby connecting with the touch chip provided in the bonding area.

Optionally, the transparent material is indium tin oxide or indium zinc oxide.

In another aspect, the present disclosure further provides a method of fabricating a touch panel, the touch panel including a touch area and a bonding area arranged at a side of the touch area, the method including: forming a plurality of touch sensing electrode blocks in the touch area; bonding a touch chip in the bonding area; and forming at least one lead configured to provide signal to the touch sensing electrode block for each touch sensing electrode block; wherein the lead is formed to pass through the touch area and extend out from a side of the touch area close to the bonding area, thereby connecting with the touch chip provided in the bonding area.

In another aspect, the present disclosure provides a display apparatus including the touch panel described herein or fabricated by the method described herein.

In the touch panel provided by the present invention, the lead configured to provide signal to the touch sensing electrode block is formed to pass through the touch area and extend out from a side of the touch area close to the bonding area, thereby connecting with the touch chip provided in the bonding area. Thus, the lead will no longer occupy spaces at both side frames, thereby being capable of achieving frameless or narrow frame. Moreover, the lead is arranged in the direction along which the black matrix strip extends, such that the light transmittance will not be affected even if the lead is made of a non-transparent metal material. The touch panel provided by the present invention is suitable for various types of display apparatuses, and particularly suitable for frameless display products or narrow frame display products.

### BRIEF DESCRIPTION OF THE FIGURES

The following drawings are merely examples for illustrative purposes according to various disclosed embodiments and are not intended to limit the scope of the present invention.

FIG. 1 is a structural schematic diagram of an existing touch display apparatus;

FIG. 2 is a structural schematic diagram of a touch panel in some embodiments according to the present disclosure;

FIG. 3 is a partially enlarged schematic diagram of the touch panel of FIG. 2;

FIG. 4 is a cross-sectional schematic diagram of a touch panel in some embodiments according to the present disclosure; and

FIG. 5 is a structural schematic diagram of a touch panel in some embodiments according to the present disclosure.

### DETAILED DESCRIPTION OF THE EMBODIMENTS

The disclosure will now be described more specifically with reference to the following embodiments. It is to be noted that the following descriptions of some embodiments are presented herein for purpose of illustration and description only. It is not intended to be exhaustive or to be limited to the precise form disclosed.

In-cell touch display apparatus is manufactured by integrating touch electrodes on an inner side or an outer side of a substrate of a liquid crystal display apparatus, such that the display apparatus are made thinner and lighter. In the conventional in-cell touch display apparatus, leads such as a touch signal line connected with a touch electrode block and a sensing signal line connected with a sensing electrode block are required to be arranged in a peripheral area of the display apparatus. Since these leads are generally made of a non-transparent metal material, they are generally arranged within an area of a bottom frame and areas of side frames, so as to avoid their impacts on light transmittance. For this reason, three frames of the display apparatus have a relatively large width, so the requirements for frameless or narrow frame are hardly to be satisfied.

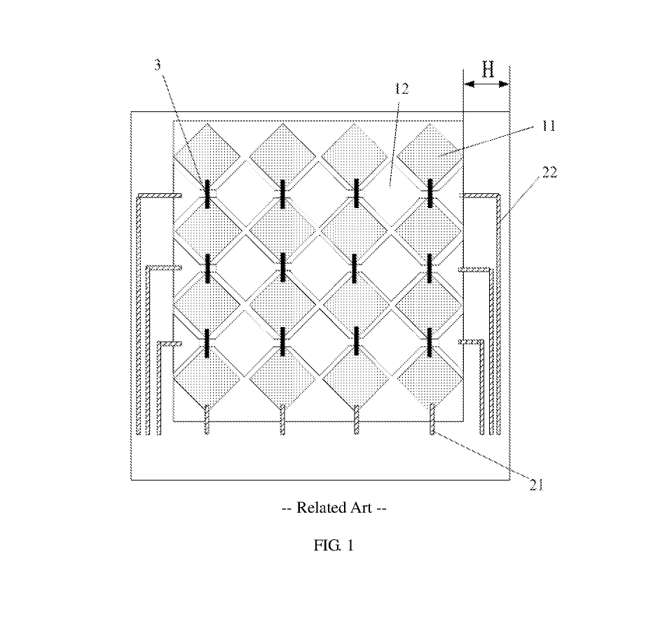

FIG. 1 is a structural schematic diagram of an existing in-cell touch display apparatus. As illustrated in FIG. 1, the touch display apparatus includes a touch area and a frame area arranged surrounding the touch area, wherein the touch area has a plurality of electrode blocks arranged in an array form, and the plurality electrode blocks includes a plurality of touch electrode blocks 11 arranged in a column direction and a plurality of sensing electrode blocks 12 arranged in a row direction. Alternatively, the plurality electrode blocks includes a plurality of touch electrode blocks arranged in a row direction and a plurality of sensing electrode blocks arranged in a column direction. Adjacent sensing electrode blocks 12 are connected with each other through a connection part arranged in the same layer as the sensing electrode 12, and adjacent touch electrode blocks 11 are connected with each other through a connection bridge 3. The touch electrode block 11 is connected with a driving chip (not illustrated) through a touch signal line 21, and the sensing electrode block 12 is connected with the driving chip through a sensing signal line 22. Generally, the touch signal line 21 and the sensing signal line 22 are made of a non-transparent metal material. Generally, the sensing signal lines 22 are provided at areas of the side frames and the touch signal lines 21 are provided at an area of the bottom frame, so as to avoid impacts on the light transmittance. As such, each of three frames of the display apparatus have to reserve a space for accommodating the sensing signal lines 22 or the touch signal lines 21. Because the sensing signal lines 22 and the touch signal lines 21 occupy spaces in these areas, frames at three sides of the display apparatus have a relatively large width, as denoted by H in FIG. 1. Thus, it is difficult for the existing in-cell touch display apparatus to satisfy the requirements of frameless or narrow frame.

Accordingly, the present disclosure provides, inter alia, a touch panel, a manufacturing method thereof, and a display apparatus having the same that substantially obviate one or more of the problems due to limitations and disadvantages of the related art. In one aspect, the present disclosure provides a touch panel, including a touch area which includes a plurality of touch sensing electrode blocks and a bonding area arranged at a side of the touch area (e.g., at a bottom side of the touch area) and provided therein with a touch chip. Each of the touch sensing electrode blocks is electrically connected with at least one lead configured to provide signal to the touch sensing electrode block, and the lead is configured to pass through the touch area and extend out from a side of the touch area close to the bonding area, thereby connecting with the touch chip provided in the bonding area.

In the touch panel provided by the present embodiment, the lead configured to provide signal to the touch sensing electrode block is formed to pass through the touch area and extend out from a side of the touch area close to the bonding area, thereby connecting with the touch chip provided in the bonding area. Thus, the lead will no longer occupy spaces at both side frames (e.g., left side frame and right side frame) compared to the prior art, thereby being capable of achieving frameless or narrow frame. The touch panel is suitable for various types of display apparatus, and particularly suitable for frameless display products or narrow frame display products.

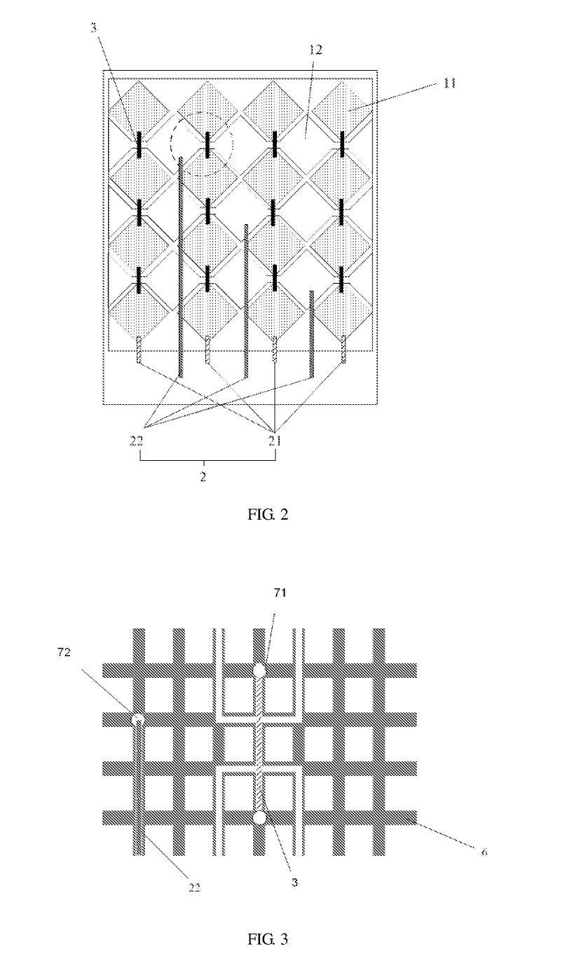

Next, the specific structure of the touch panel in embodiments will be described with reference to FIG. 2 to FIG. 4. FIG. 2 is a structural schematic diagram of a touch panel in some embodiments according to the present disclosure; FIG. 3 is a partially enlarged schematic diagram illustrating an area of the touch panel of FIG. 2 encircled by the dotted line; and FIG. 4 is a cross-sectional schematic diagram of a touch panel in some embodiments according to the present disclosure.

The touch panel in the present embodiment includes a touch area and a bonding area arranged at a side of the touch area. The touch area includes a plurality of touch sensing electrode blocks arranged in an array form, and the bonding area provided therein with a touch chip (not illustrated). Each of the touch sensing electrode blocks is electrically connected with at least one lead 2 configured to provide signal to the touch sensing electrode block, and the lead 2 is configured to pass through the touch area and extend out from a side of the touch area close to the bonding area, thereby connecting with the touch chip provided in the bonding area.

In FIG. 2, the bonding area is arranged below the touch area, such that the lead 2 can directly connected with the touch chip provided in the bonding area after extending out from a side of the touch area close to the bonding area. However, the present invention is not limited thereto, the bonding area may be arranged at another side of the display apparatus and the lead 2 extends out from this another side accordingly, depending on actual needs.

As illustrated in FIG. 2, the touch panel includes a plurality of touch sensing electrode blocks arranged in an array form. The plurality of touch sensing electrode blocks may include the touch electrode blocks 11 in a column direction and the sensing electrode blocks 12 in a row direction. Alternatively, the plurality of touch sensing electrode blocks may include the touch electrode blocks in a row direction and the sensing electrode blocks in a column direction. Adjacent sensing electrode blocks 12 are connected with each other through a connection part arranged in the same layer as the sensing electrode 12, and adjacent touch electrode blocks 11 are connected with each other through a connection bridge 3. The lead 2 includes a touch signal line 21 configured to provide touch signal to the touch electrode block 11 and a sensing single line 22 configured to provide sensing signal to the sensing electrode block 12. The connection bridge 3 is arranged in a same layer as the touch signal line 21 and the sensing signal line 22, and the connection bridge 3 is insulated from the connection part. The touch electrode blocks 11 in a same column are electrically connected with a same touch signal line 21, and the sensing electrode blocks 12 in a same row are electrically connected with a same sensing signal line 22. In the touch panel provided by the present embodiment, the sensing signal line 22 is configured to pass through the touch area and extend out from a side of the touch area close to the bonding area, thereby connecting with the touch chip provided in the bonding area, and the touch signal line 21 is configured to directly extend out from the side of the touch area and connect with the touch chip. By arranging the sensing signal line 22 in this manner, the spaces at the frames at both sides of the touch panel can be saved, such that frameless or narrow frame can be achieved.

In the touch panel provided by the present embodiment, the lead may be electrically connected with the touch sensing electrode blocks via a through hole. Optionally, an insulating layer is arranged between the touch sensing electrode blocks and the leads, and there are provided first through holes at positions of the insulating layer corresponding to both ends of the connection bridge, a second through hole at a position of the insulating layer corresponding to one end of the sensing signal line, and a third through hold at a position of the insulating layer corresponding to one end of the touch signal line. Adjacent touch electrode blocks are electrically connected with a corresponding connection bridge via corresponding first through holes, the sensing signal line is electrically connected with the sensing electrode block via the second through hole, and the touch signal line is electrically connected with the touch electrode block via the third through hole. Optionally, the touch panel further includes a black matrix structure arranged within the touch area. Optionally, the black matrix structure is made of an insulating material and is arranged between the touch sensing electrode blocks and the leads. Optionally, there are provided first through holes at positions of the black matrix structure corresponding to both ends of the connection bridge, a second through hole at a position of black matrix structure corresponding to one end of the sensing signal line, and a third through hold at a position of the black matrix structure corresponding to one end of the touch signal line. Adjacent touch electrode blocks are electrically connected with a corresponding connection bridge via corresponding first through holes, the sensing signal line is electrically connected with the sensing electrode block via the second through hole, and the touch signal line is electrically connected with the touch electrode block via the third through hole.

As illustrated in FIGS. 3 and 4, the touch panel further includes a black matrix structure 6 arranged within the touch area and between the touch sensing electrode blocks and the leads 2. The black matrix structure 6 is made of an insulating material. First through holes 71 are provided at positions of the black matrix structure 6 corresponding to both ends of the connection bridge 3, and a second through hole 72 is provided at a position of the black matrix structure corresponding to one end of the sensing signal line 22. Adjacent touch electrode blocks is connected with the corresponding connection bridge 3 through the first through holes 71, the sensing signal line 22 is connected with the sensing electrode block 12 through the second through hole 72. In other words, the black matrix structure 6 that is made of an insulating material can function as an insulating layer, so that there is no need to arrange an insulating layer separately. As illustrated in FIG. 4, the sensing electrode block 12 which is arranged on a color filter substrate 8 is electrically connected with the sensing signal line 22 via the second through hole 72 provided in the black matrix structure 6, thereby no need to arrange an insulating layer separately.

In other words, there are two solutions in the present disclosure to make a layer where the touch sensing electrode block is located be insulated from a layer where the lead is located. One is to arrange an insulating layer between the touch sensing electrode block and the lead, such that they are insulated from each other; and the other one is to arrange a black matrix structure that is made of an insulating material between the touch sensing electrode block and the lead without the need to arrange an insulating layer, i.e., the black matrix structure 6 also functions as an insulating layer.

Optionally, the black matrix structure includes black matrix strips in a row direction and black matrix strips in a column direction, and the lead extends along the black matrix strip in the row direction and/or the black matrix strip in the column direction and is covered by the black matrix strip. As illustrated in FIGS. 2 and 3, the black matrix structure 6 includes black matrix strips in a row direction and black matrix strips in a column direction, and each of the sensing signal line 22 and the connection bridge 3 extends along the black matrix strip in the column direction and is covered by the black matrix strip. Needless to say, the touch signal line 21 in FIG. 2 also extends along the black matrix strip in the column direction and covered by the black matrix strip.

Because the lead 2 is arranged to extend along the black matrix strip and be covered by the black matrix strip, the light transmittance will not be decreased even if the lead 2 is made of a non-transparent metal material.

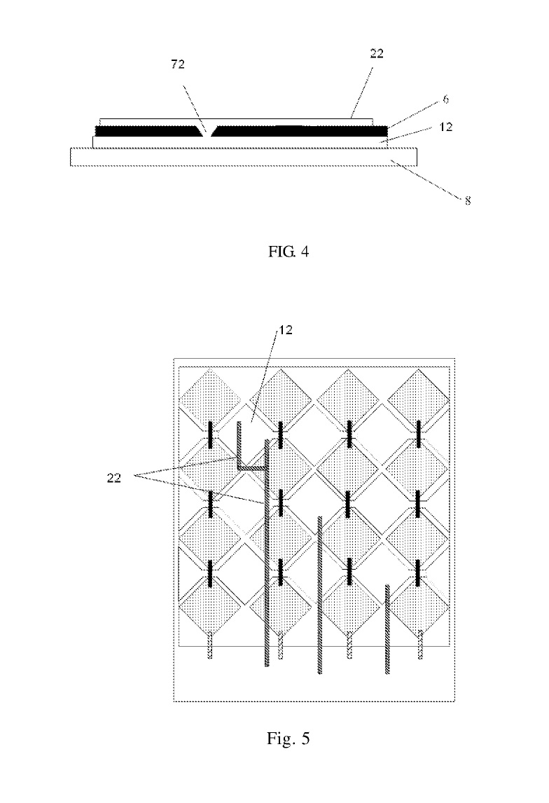

Optionally, each of the touch sensing electrode blocks is electrically connected with a plurality of leads, and the plurality of leads are connected with each other in parallel. As such, not only the touch sensitivity can be improved, but also can reduce the resistance of the lead. FIG. 5 is a structural schematic diagram of a touch panel in some embodiments according to the present disclosure. As illustrated in FIG. 5, the sensing electrode block 12 is electrically connected with two leads 22, portions of which are connected in parallel, such that the total resistance is reduced. The two leads in FIG. 5 being partially connected in parallel is illustrated as an example, and the present invention is not limited thereto.

It should be noted that embodiments of the present disclosure are described as above with respect to a mutual-capacitive touch panel as an example, but the present invention is not limited thereto. The principle in the above embodiments can be applied to various types of touch panels other than the mutual-capacitive touch panel.

It should be noted that the electrode blocks in the column direction are the touch electrode blocks 11 and the electrode blocks in the row direction are the sensing electrode blocks 12 in FIGS. 2 and 4, but the present invention is not limited thereto. According to actual needs, the electrode blocks in the row direction may be touch electrode blocks and the electrode blocks in the column direction may be sensing electrode blocks.

Needless to say, specific implementations of the above embodiments can be varied in different ways; for example, the specific arrangement position and the extending direction of the lead may be adjusted, depending on actual needs.

In another aspect, the present disclosure further provides a method of fabricating a touch panel, the touch panel including a touch area and a bonding area arranged at a side of the touch area, and the method includes: forming, through a deposition process, a plurality of touch sensing electrode blocks on a color filter substrate, the touch sensing electrode block is made of a transparent conductive material such as indium tin oxide (ITO) or indium zinc oxide (IZO); depositing a layer of a black matrix material and patterning the black matrix material to form a black matrix structure, the black matrix material being an insulating material; and forming, on the black matrix structure, at least one lead configured to provide signal to the touch sensing electrode block for each touch sensing electrode block, wherein the lead is formed to be electrically connected with the touch sensing electrode block via a through hole in the matrix structure, and the lead is formed to pass through the touch area and extend out from a side of the touch area close to the bonding area, thereby connecting with a touch chip provided in the bonding area, the lead being made of a metal material such as Mo/Al/Mo.

In another aspect, the present disclosure further provides a method of fabricating a touch panel, the touch panel including a touch area and a bonding area arranged at a side of the touch area, and the method includes: forming a black matrix structure on a color filter substrate; forming a plurality of touch sensing electrode blocks on the black matrix structure; forming an insulating layer on the touch sensing electrode blocks; forming, on the insulating layer, at least one lead configured to provide signal to the touch sensing electrode block for each touch sensing electrode block, wherein the lead is formed to be electrically connected with the touch sensing electrode via a through hole in the insulating layer, and the lead is formed to pass through the touch area and extend out from a side of the touch area close to the bonding area, thereby connecting with the touch chip provided in the bonding area.

In another aspect, the present disclosure further provides a method of fabricating a touch panel, the touch panel including a touch area and a bonding area arranged at a side of the touch area, and the method includes: forming a plurality of touch sensing electrode blocks in the touch area; bonding a touch chip in the bonding area; and forming at least one lead configured to provide signal to the touch sensing electrode block for each touch sensing electrode block; wherein the lead is formed to pass through the touch area and extend out from a side of the touch area close to the bonding area, thereby connecting with the touch chip provided in the bonding area.

In another aspect, the present disclosure further provides a display apparatus having any one of the above touch panels. The display apparatus may be any product or component with display function such as a liquid crystal panel, an electronic paper, a mobile phone, a tablet computer, a television, a monitor, a laptop computer, a digital photo frame, a navigator or the like.

It should be understood that the foregoing implementations are merely exemplary embodiments used for the purpose of illustrating the principle of the present invention, and the present invention is not limited thereto. Various modifications and improvements can be made by those skilled in the art without departing from the spirit and essence of the present invention, and these modifications and improvements shall also regarded as the protection scope of the present invention.

What is claimed is:

1. A touch panel, comprising a touch area having a plurality of touch sensing electrode blocks and a bonding area arranged at a side of the touch area and provided therein with a touch chip, wherein each of the touch sensing electrode blocks is electrically connected with at least one lead configured to provide signal to the touch sensing electrode block, and the lead is configured to pass through the touch area and extend out from a side of the touch area close to the bonding area, thereby connecting with the touch chip provided in the bonding area.

2. The touch panel of claim 1, wherein each of the touch sensing electrode block is connected with a plurality of leads configured to provide signal to the touch sensing electrode block, and the plurality of leads are connected with each other in parallel.

3. The touch panel of claim 1, wherein an insulating layer is arranged between the touch sensing electrode block and the lead, and a through hole is provided at a position of the insulating layer corresponding to one end of the lead, the lead being electrically connected with the touch sensing electrode block via the through hole.

4. The touch panel of claim 1, further comprising a black matrix structure arranged within the touch area, and the black matrix structure comprises a black matrix strip in a row direction and a black matrix strip in a column direction, the lead being configured to extend along the black matrix strip in the row direction and/or the black matrix strip in the column direction and be covered by the black matrix strip.

5. The touch panel of claim 4, wherein the black matrix structure is arranged between the touch sensing electrode block and the lead and is made of an insulating material, and
a through hole is provided at a position of the black matrix structure corresponding to one end of the lead, the lead being electrically connected with the touch sensing electrode block via the through hole.

6. The touch panel of claim 1, wherein the plurality of touch sensing electrode blocks are arranged in a same layer and arranged in an array form, and comprises sensing electrode blocks in a row direction and touch electrode blocks in a column direction, and
adjacent sensing electrode blocks are connected with each other through a connection part arranged in the same layer as the sensing electrode block, and adjacent touch electrode blocks are connected with each other through a connection bridge.

7. The touch panel of claim 6, further comprising a black matrix structure arranged within the touch area, wherein the black matrix structure comprises a black matrix strip in a row direction and a black matrix strip in a column direction,
the lead is configured to extend along the black matrix strip in the row direction and/or the black matrix strip in the column direction and be covered by the black matrix strip, and
the connection bridge is configured to extend along the black matrix strip in the column direction and covered by the black matrix strip.

8. The touch panel of claim 6, wherein the connection bridge and the lead are arranged in a same layer, and the connection bridge is insulated from the connection part.

9. The touch panel of claim 6, wherein the lead comprises a sensing single line configured to provide sensing signal to the sensing electrode block and a touch signal line configured to provide touch signal to the touch electrode block, the sensing electrode blocks in a same row being electrically connected with a same sensing signal line, the touch electrode blocks in a same column being electrically connected with a same touch signal line.

10. The touch panel of claim 5, further comprising a color filter substrate, and the touch sensing electrode blocks are arranged on the color filter substrate.

11. A method of fabricating the touch panel of claim 3, comprising:
forming a black matrix structure on a color filter substrate;
forming a plurality of touch sensing electrode blocks on the black matrix structure;
forming an insulating layer on the touch sensing electrode blocks;
forming, on the insulating layer, at least one lead configured to provide signal to the touch sensing electrode block for each touch sensing electrode block,
wherein the lead is formed to be electrically connected with the touch sensing electrode block via a through hole in the insulating layer, and the lead is formed to pass through the touch area and extend out from a side of the touch area close to the bonding area, thereby connecting with the touch chip provided in the bonding area.

12. A method of fabricating the touch panel of claim 5, comprising:
forming, through a deposition process, a plurality of touch sensing electrode blocks on a color filter substrate, the touch sensing electrode block is made of a transparent conductive material;
depositing a layer of a black matrix material and patterning the black matrix material to form a black matrix structure, the black matrix material being an insulating material; and
forming, on the black matrix structure, at least one lead configured to provide signal to the touch sensing electrode block for each touch sensing electrode block,
wherein the lead is formed to be electrically connected with the touch sensing electrode block via a through hole in the matrix structure, and the lead is formed to pass through the touch area and extend out from a side of the touch area close to the bonding area, thereby connecting with the touch chip provided in the bonding area.

13. The method of claim 12, wherein the transparent material is indium tin oxide or indium zinc oxide.

14. A method of fabricating a touch panel having a touch area and a bonding area arranged at a side of the touch area, comprising:
forming a plurality of touch sensing electrode blocks in the touch area;
bonding a touch chip in the bonding area; and
forming at least one lead configured to provide signal to the touch sensing electrode block for each touch sensing electrode block; wherein the lead is formed to pass through the touch area and extend out from a side of the touch area close to the bonding area, thereby connecting with the touch chip provided in the bonding area.

15. A display apparatus, comprising the touch panel of claim 1.

16. The display apparatus of claim 15, wherein each of the touch sensing electrode block is connected with a plurality of leads configured to provide signal to the touch sensing electrode block, and the plurality of leads are connected with each other in parallel.

17. The display apparatus of claim 15, wherein an insulating layer is arranged between the touch sensing electrode block and the lead, and a through hole is provided at a position of the insulating layer corresponding to one end of the lead, the lead being electrically connected with the touch sensing electrode block via the through hole.

18. The display apparatus of claim 15, wherein the touch panel further comprises a black matrix structure arranged within the touch area, and the black matrix structure comprises a black matrix strip in a row direction and a black matrix strip in a column direction, the lead being configured to extend along the black matrix strip in the row direction and/or the black matrix strip in the column direction and be covered by the black matrix strip.

19. The display apparatus of claim 18, wherein the black matrix structure is arranged between the touch sensing electrode block and the lead and is made of an insulating material, and a through hole is provided at a position of the black matrix structure corresponding to one end of the lead, the lead being electrically connected with the touch sensing electrode block via the through hole.

20. The display apparatus of claim 15, wherein the plurality of touch sensing electrode blocks are arranged in a same layer and arranged in an array form, and comprises sensing electrode blocks in a row direction and touch electrode blocks in a column direction, and
adjacent sensing electrode blocks are connected with each other through a connection part arranged in the same layer as the sensing electrode block, and adjacent touch electrode blocks are connected with each other through a connection bridge.
